(19) United States
(12) Patent Application Publication
(10) Pub. No.: US 2025/0192338 A1
(43) Pub. Date: Jun. 12, 2025

(54) TRACTION BATTERY PACK VENTING SYSTEM

(71) Applicant: Ford Global Technologies, LLC, Dearborn, MI (US)

(72) Inventors: Derek Timothy Taylor, Waterford, MI (US); Nicholas Braeseker, Novi, MI (US); Robert Reiners, Ypsilanti, MI (US); Nathan Wieseler, Beverly Hills, MI (US)

(21) Appl. No.: 18/914,442

(22) Filed: Oct. 14, 2024

Related U.S. Application Data
(60) Provisional application No. 63/607,888, filed on Dec. 8, 2023.

(51) Int. Cl. H01M 50/30; H01M 50/224; H01M 50/233

(52) U.S. Cl. CPC H01M 50/30; H01M 50/224; H01M 50/233

(57) ABSTRACT

A battery pack venting system includes an enclosure assembly having an enclosure wall, and an enclosure support beam assembly secured directly to the enclosure wall. The enclosure support beam assembly provides a venting channel that extends along the enclosure wall. One or more cell stacks are disposed within the enclosure assembly. The enclosure support beam assembly is disposed between the enclosure wall and the one or more cell stacks. At least one battery pack vent is configured to communicate vent byproducts from the venting channel to an area outside the enclosure assembly.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to communicating vent byproducts from battery cells to an area outside the battery pack.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack venting system, including: an enclosure assembly having an enclosure wall; an enclosure support beam assembly secured directly to the enclosure wall, the enclosure support beam assembly providing a venting channel that extends along the enclosure wall; one or more cell stacks disposed within the enclosure assembly, the enclosure support beam assembly disposed between the enclosure wall and the one or more cell stacks; at least one battery pack vent configured to communicate vent byproducts from the venting channel to an area outside the enclosure assembly.

In some aspects, the techniques described herein relate to a battery pack venting system, wherein the enclosure support beam assembly includes an beam wall and an inner bracket, the beam wall spaced a distance from the enclosure wall, the inner bracket spanning between the beam wall and the enclosure wall.

In some aspects, the techniques described herein relate to a battery pack venting system, wherein the beam wall is secured to an enclosure floor of the enclosure assembly and to the enclosure wall.

In some aspects, the techniques described herein relate to a battery pack venting system, wherein the beam wall includes a horizontally facing side extending upward from an enclosure floor of the enclosure assembly, and a vertically facing side extending from the horizontally facing side to the enclosure wall.

In some aspects, the techniques described herein relate to a battery pack venting system, wherein the vertically facing side spans over the inner bracket.

In some aspects, the techniques described herein relate to a battery pack venting system, wherein the vertically facing side includes a plurality of beam vent openings configured to communicate vent byproducts to an area between the beam wall and the enclosure wall.

In some aspects, the techniques described herein relate to a battery pack venting system, wherein the inner bracket is secured directly to the beam wall and the enclosure wall.

In some aspects, the techniques described herein relate to a battery pack venting system, wherein the inner bracket has a C-shaped cross-sectional profile.

In some aspects, the techniques described herein relate to a battery pack venting system, wherein the venting channel is provided between the inner bracket and the beam wall.

In some aspects, the techniques described herein relate to a battery pack venting system, wherein the enclosure support beam assembly is welded to the enclosure wall.

In some aspects, the techniques described herein relate to a battery pack venting system, wherein the enclosure support beam assembly and the enclosure wall are each a metallic material.

In some aspects, the techniques described herein relate to a battery pack venting system, wherein the enclosure support beam assembly is spaced a distance from the one or more cell stacks.

In some aspects, the techniques described herein relate to a battery pack venting system, wherein the venting channel is configured to receive the vent byproducts at a forward axial end of the venting channel and at an aft axial end of the venting channel.

In some aspects, the techniques described herein relate to a battery pack venting system, wherein the at least one battery pack vent is configured to communicate vent byproducts directly from the venting channel.

In some aspects, the techniques described herein relate to a battery pack venting system, wherein the one or more cells stacks includes at least one cell stack on an upper tier and at least one cell stack on a lower tier.

In some aspects, the techniques described herein relate to a battery pack venting system, wherein the enclosure assembly is an enclosure tray.

In some aspects, the techniques described herein relate to a battery pack venting system, including: an enclosure assembly; a plurality of cell stacks within the enclosure assembly, at least one of cell stacks on a first tier, at least one of the cell stacks on a second tier; an enclosure support beam assembly disposed along a side of the plurality of cell stacks, between an enclosure wall of the enclosure assembly and the plurality of cell stacks, the enclosure support beam assembly including a beam wall and an inner bracket, the beam wall spaced a distance from the enclosure wall, the inner bracket spanning between the beam wall and the enclosure wall; and at least one battery pack vent configured to communicate vent byproducts from within the enclosure support beam assembly to an area outside the enclosure assembly.

In some aspects, the techniques described herein relate to a battery pack venting system, wherein the enclosure support beam assembly is secured directly to the enclosure wall.

In some aspects, the techniques described herein relate to a battery pack venting system, wherein the enclosure support beam assembly includes a vertically facing side having a plurality of venting apertures that open downward toward the inner bracket.

In some aspects, the techniques described herein relate to a battery pack venting system, wherein the at least one battery pack vent is configured to communicate vent byproducts from within a venting channel of the enclosure support beam assembly, the venting channel established between the inner bracket and the beam wall.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1.

FIG. 3 illustrates a perspective view of an enclosure tray and support beam assemblies from the battery pack of FIG. 2.

FIG. 4 illustrates a section view taken at line 4-4 in FIG. 2.

FIG. 5 illustrates a perspective view of a support beam assembly from the battery pack of FIG. 2.

### DETAILED DESCRIPTION

This disclosure details exemplary systems and methods utilized to communicate vent byproducts from battery cells to an area outside the battery pack. The systems and methods involve communicating the vent byproducts along a tortuous path to extend a time the vent byproducts are contained within the battery pack before being vented from the battery pack. Increasing the time that the vent byproducts spend inside the battery pack can help to lower a temperature of the vent byproducts before the vent byproducts are vented from the battery pack. These and other features are discussed in greater detail in the following paragraphs.

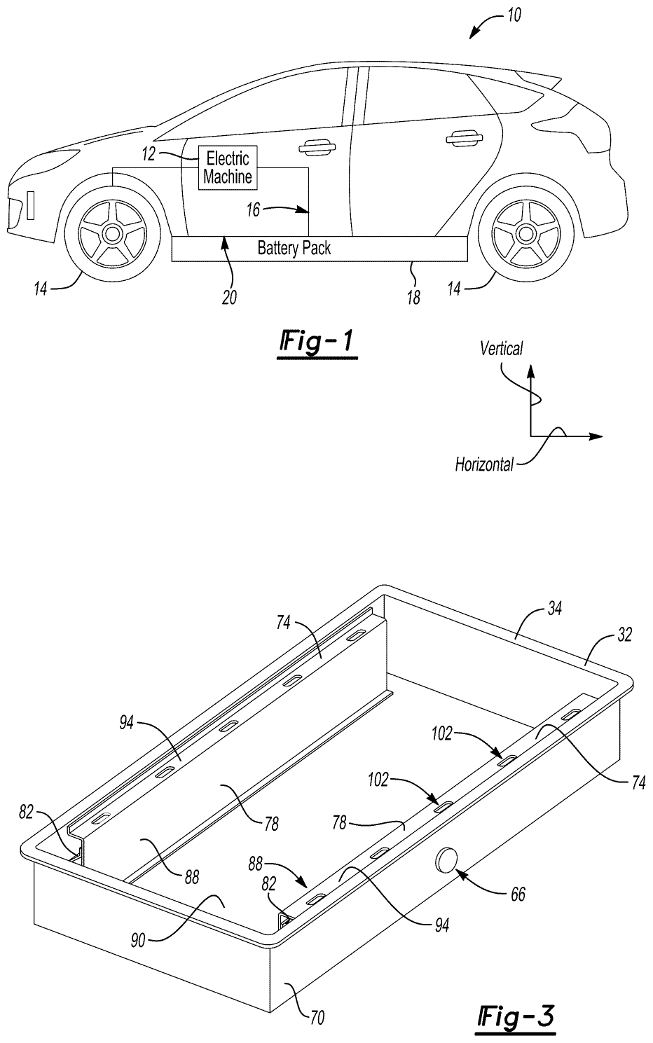

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack venting system that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

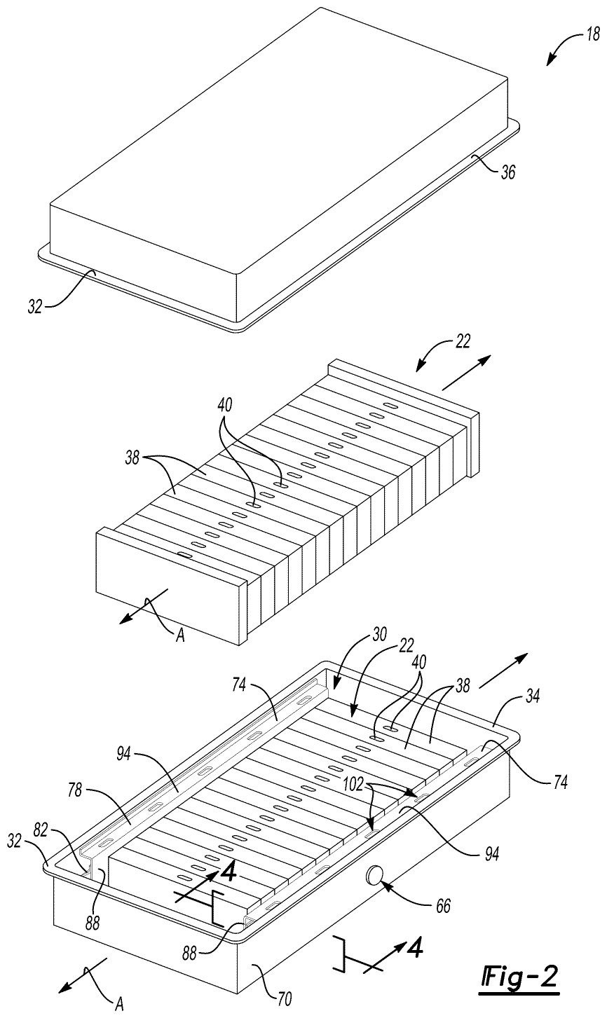

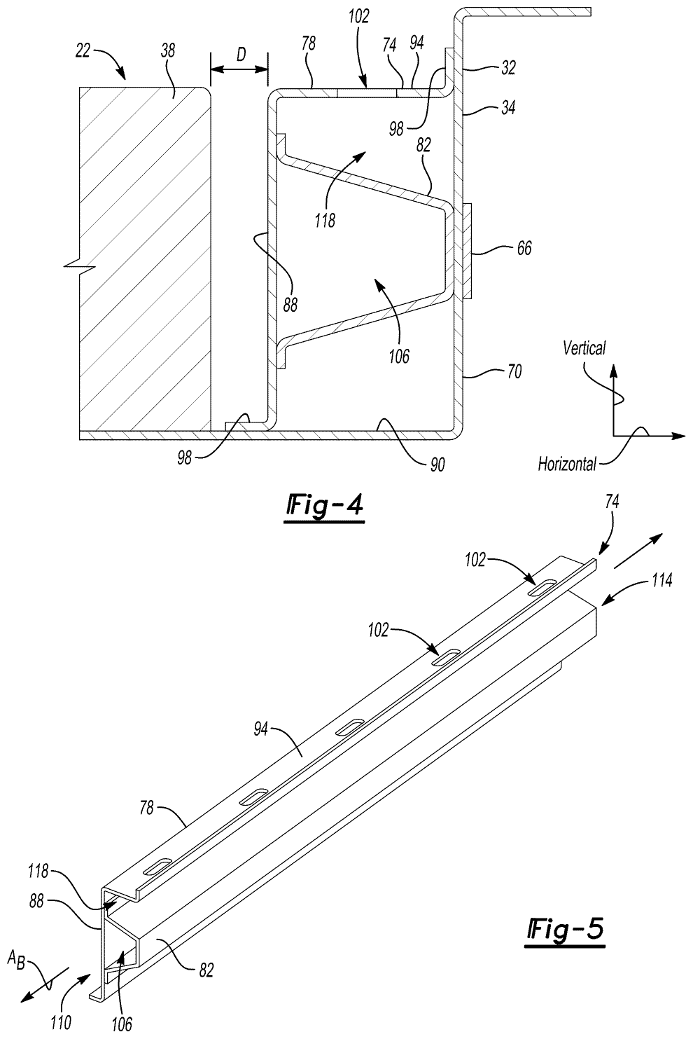

With reference to FIGS. 2-5, the traction battery pack 18 includes a plurality of cell stacks 22 housed within an interior area 30 of an enclosure assembly 32. In this example, the enclosure assembly includes an enclosure tray 34 and an enclosure cover 36. The enclosure tray 34 can be secured to an enclosure cover 36 or both to enclose the cell stacks 22 and other battery internal components within the interior area 30.

Each cell stack 22 includes a plurality of battery cells 38 stacked side-by-side relative to one another along a respective cell stack axis A. The battery cells 38 store and supply electrical power for powering various components of the electrified vehicle 10. In this example, the battery pack 18 includes one cell stack 22 on an upper tier and another cell stack 22 on a lower tier. The upper tier is vertically above the lower tier. Vertical, for purposes of this disclosure, is with reference to ground in an general orientation of the battery pack 18 when installed within a vehicle. As the battery pack 18 includes both the upper tier and the lower tier, the battery pack 18 can be considered a multi-tier battery pack.

The example battery pack 18 includes a single one of the cell stacks 22 on the upper tier and a single one of the cell stacks 22 on the lower tier. In other examples, the upper and lower tiers could each include more than one of the cell stacks 22.

In the exemplary embodiment, the battery cells 38 are lithium-ion, pouch-style battery cells. However, battery cells having other geometries (cylindrical, prismatic, etc.) and/or chemistries (nickel-metal hydride, lead-acid, etc.) could alternatively be utilized within the scope of this disclosure.

The cell stacks 22 and the battery cells 38 are shown schematically. The cell stacks 22 can, in addition to the battery cells 38, include dividers, thermal interface materials, adhesives, endplates, and other materials between the individual battery cells 38. Although a specific number of the cell stacks 22 are illustrated in the various figures of this disclosure, the traction battery pack 18 could include any number of the cell stacks 22.

From time to time, pressure and thermal energy within at least one of the battery cells 38 in the cell stacks 22 can increase. This can lead to the battery cell 38 discharging a flow of vent byproducts, which can include gas and debris. The vent byproducts can be discharged from the battery cell 38 through a cell vent 40 within a housing of the battery cell 38. The cell vent 40 can be a membrane that yields in response to increased pressure and thermal energy within the battery cell 38. The cell vent 40 can also be a ruptured area of the associated battery cell 38.

The enclosure tray 34 of the enclosure assembly 32 includes an enclosure vent 66 extending through an enclosure wall 70 of the enclosure tray 34. In FIGS. 2-4, a single enclosure vent 66 is shown on a driver side of the battery pack 18. The battery pack 18 includes another enclosure vent 66 on a passenger side. In other examples, the battery pack 18 could include multiple enclosure vents 66 on the driver side and multiple enclosure vents 66 on the passenger side.

The enclosure vent 66 is configured to discharge vent byproducts from the battery pack 18. This disclosure is directed toward guiding vent byproducts within the interior area 30 toward the enclosure vent 66.

Exemplary embodiments of this disclosure rely on structural elements of the traction battery pack 18 to guide the vent byproducts toward the enclosure vent 66. As structural elements are used, additional components that are devoted solely to communicating vent byproducts are not required.

Exemplary embodiments of this disclosure guide the vent byproducts toward the enclosure vent 66 along a tortuous path. When compared to guiding the vent byproducts directly toward the enclosure vent 66, the guiding along a tortuous path lengthens the time the vent byproducts are contained within the enclosure assembly 32 providing time for the vent byproducts to cool prior to being discharged to the enclosure vent 66.

In the exemplary embodiment, the structural elements of the traction battery pack 18 used to guide the vent byproducts comprise a pair of enclosure support beam assemblies 74, which are disposed along opposing enclosure walls 70 of the enclosure tray 34. In this example, the enclosure support beam assemblies 74 are secured directly to the enclosure walls 70.

The cell stacks 22 are disposed between the support beam assemblies 74 within the interior area 30. The cells stacks 22 are spaced a distance D from the support beam assemblies 74 in this example.

Each of the support beam assemblies 74 includes a beam wall 78 and an inner bracket 82. The beam wall 78 includes a horizontally facing side 88 that extends upward from an enclosure floor 90 of the enclosure tray 34. The beam wall 78 additionally includes a vertically facing side 94 extending from a vertically upper portion of the horizontally facing side 86 to the enclosure wall 70. Attachment flanges 98 extend transversely from a lower edge of the horizontally facing side 86 and transversely from an outboard edge of the vertically facing side 94. The attachment flanges 98 are used to secure the beam wall 78 to the enclosure floor 90 and the enclosure wall 70. In this example, the beam wall 78, the inner bracket 82, as well as the enclosure tray 34, are metallic materials, which can be metal or metal alloy. In some specific examples, one or more of the beam wall 78, the inner bracket 82, and the enclosure tray 34 can be aluminum or steel. Using a metal or metal alloy material can facilitate thermal transfer and help to take on thermal energy from the vent byproducts being communicated along the tortuous path. The beam wall 78 can be secured to the enclosure floor 90 and the enclosure wall 70 via a welding process.

The inner bracket 82 spans between the horizontally facing side 88 of the beam wall 78 and the enclosure wall 70. The vertically facing side 94 of the beam wall 78 spans over the inner bracket 82. The vertically facing side 94 includes, in this example, a plurality of venting apertures 102 opening downward toward the inner bracket 82.

The example inner bracket 82 is secured directly to both the beam wall 78 and the enclosure wall 70 via welds, for example. The example inner bracket 82 has a generally C-shaped cross-sectional profile. The inner bracket 82, as well as the remaining portions of the enclosure support beam assembly 74 can help the enclosure assembly withstand a load, such as a load applied to an outboard side of the battery pack 18.

The inner bracket 82 together with, in this example, the horizontally facing side 88 of the beam wall 78 establish a venting channel 106 that extends along the enclosure wall 70. The enclosure vent 66 is configured to discharge vent byproducts from within the venting channel 106 to an area outside the battery pack 18. The venting channel 106 is open at a forward axial end 110 of the venting channel 106 as well as at an aft axial end 114 of the venting channel 106.

When one or more battery cells 38 within cell stack 22 of the lower tier discharge vent byproducts, the vent byproducts flow outward toward the enclosure support beam assembly 74. At least some of the vent byproducts can be redirected by the horizontally facing side 88 of the beam wall 78 to flow in a direction aligned generally with a longitudinal axis AB of the support beam assembly 74. The vent byproducts move toward the forward axial end 110 or the aft axial end 114 of the battery pack 18. After reached the forward axial end 110 or the aft axial end 114 of the venting channel 106, the vent byproducts can enter the venting channel 106. A pressure differential between the area outside the venting channel 106 and the area inside the venting channel 106 tends to draw the vent byproducts into the venting channel 106.

The vent byproducts move through the venting channel 106 until reaching the enclosure vent 66. At the enclosure vent 66, the vent byproducts can be discharged from the battery pack. Thus, vent byproducts discharged from battery cells 38 in the first tier of cell stacks 22 move in at least two directions (forward and aft) after flowing outside of an area between cell stacks 22 of the battery pack 18.

In this example, the enclosure vent 66 is in the enclosure wall 70. In another example, the support beam assemblies 74 could be reconfigured to reposition the venting channel 106 and to communicate the vent byproducts to an enclosure vent 66 in the enclosure floor 90. The enclosure vent 66, when repositioned to be in the enclosure floor 90, could extend through a shear plate beneath the battery pack 14.

As to the battery cells 38 of the cell stack 22 within the upper tier, during a venting event where one more of those battery cells 38 discharges vent byproducts, the vent byproducts flow initially out from between the cell stacks 22 toward the support beam assembly 74. At least some of the vent byproducts can be redirected by the enclosure cover 36 downward to move through the venting apertures 102 down into an area 118 between the vertically facing side 94 and the inner bracket 82.

The vent byproducts then move forward or aft within the area 118 and exit the area 118 near the forward axial end 110 of the venting channel 106 or the aft axial end 114 of the venting channel 106. The vent byproducts are drawn into the venting channel 106 and then communicated through the venting channel 106 to the enclosure vent 66. Thus, vent products discharge from battery cells 38 within the upper tier of cell stacks 22 also move in at least two directions (forward and aft) prior to being discharged through the enclosure vent 66.

Features of the disclosed embodiment include utilizing structural members, here enclosure support beam assemblies, to facilitate communicating vent byproducts from a battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
an enclosure assembly having an enclosure wall;
an enclosure support beam assembly secured directly to the enclosure wall, the enclosure support beam assembly providing a venting channel that extends along the enclosure wall;
one or more cell stacks disposed within the enclosure assembly, the enclosure support beam assembly disposed between the enclosure wall and the one or more cell stacks;
at least one battery pack vent configured to communicate vent byproducts from the venting channel to an area outside the enclosure assembly.

2. The battery pack venting system of claim 1, wherein the enclosure support beam assembly includes an beam wall and an inner bracket, the beam wall spaced a distance from the enclosure wall, the inner bracket spanning between the beam wall and the enclosure wall.

3. The battery pack venting system of claim 2, wherein the beam wall is secured to an enclosure floor of the enclosure assembly and to the enclosure wall.

4. The battery pack venting system of claim 2, wherein the beam wall includes a horizontally facing side extending upward from an enclosure floor of the enclosure assembly, and a vertically facing side extending from the horizontally facing side to the enclosure wall.

5. The battery pack venting system of claim 4, wherein the vertically facing side spans over the inner bracket.

6. The battery pack venting system of claim 4, wherein the vertically facing side includes a plurality of beam vent openings configured to communicate vent byproducts to an area between the beam wall and the enclosure wall.

7. The battery pack venting system of claim 3, wherein the inner bracket is secured directly to the beam wall and the enclosure wall.

8. The battery pack venting system of claim 2, wherein the inner bracket has a C-shaped cross-sectional profile.

9. The battery pack venting system of claim 2, wherein the venting channel is provided between the inner bracket and the beam wall.

10. The battery pack venting system of claim 1, wherein the enclosure support beam assembly is welded to the enclosure wall.

11. The battery pack venting system of claim 1, wherein the enclosure support beam assembly and the enclosure wall are each a metallic material.

12. The battery pack venting system of claim 1, wherein the enclosure support beam assembly is spaced a distance from the one or more cell stacks.

13. The battery pack venting system of claim 1, wherein the venting channel is configured to receive the vent byproducts at a forward axial end of the venting channel and at an aft axial end of the venting channel.

14. The battery pack venting system of claim 1, wherein the at least one battery pack vent is configured to communicate vent byproducts directly from the venting channel.

15. The battery pack venting system of claim 1, wherein the one or more cells stacks comprises at least one cell stack on an upper tier and at least one cell stack on a lower tier.

16. The battery pack venting system of claim 1, wherein the enclosure assembly is an enclosure tray.

17. A battery pack venting system, comprising:
an enclosure assembly;
a plurality of cell stacks within the enclosure assembly, at least one of cell stacks on a first tier, at least one of the cell stacks on a second tier;
an enclosure support beam assembly disposed along a side of the plurality of cell stacks, between an enclosure wall of the enclosure assembly and the plurality of cell stacks, the enclosure support beam assembly including a beam wall and an inner bracket, the beam wall spaced a distance from the enclosure wall, the inner bracket spanning between the beam wall and the enclosure wall; and
at least one battery pack vent configured to communicate vent byproducts from within the enclosure support beam assembly to an area outside the enclosure assembly.

18. The battery pack venting system of claim 17, wherein the enclosure support beam assembly is secured directly to the enclosure wall.

19. The battery pack venting system of claim 17, wherein the enclosure support beam assembly includes a vertically facing side having a plurality of venting apertures that open downward toward the inner bracket.

20. The battery pack venting system of claim 17, wherein the at least one battery pack vent is configured to communicate vent byproducts from within a venting channel of the enclosure support beam assembly, the venting channel established between the inner bracket and the beam wall.
